(19) United States
(12) Patent Application Publication
(10) Pub. No.: US 2019/0138924 A1
(43) Pub. Date: May 9, 2019

(54) QUANTUM MECHANICAL PROPABILISTIC APPARATUS TO MEASURE, FORECAST, VISUALIZE HUMANOID MENTAL STATUSES

(71) Applicant: Olaf Cames, Orlando, FL (US)

(72) Inventor: Olaf Cames, Orlando, FL (US)

(21) Appl. No.: 16/157,097

(22) Filed: Oct. 11, 2018

Related U.S. Application Data
(60) Provisional application No. 62/570,372, filed on Oct. 10, 2017.

(51) Int. Cl. G06N 7/00; G06N 10/00; G06N 20/00

(52) U.S. Cl. CPC G06N 7/005; G06N 20/00; G06N 10/00

(57) ABSTRACT

This invention is a quantum mechanical probabilistic apparatus measuring, forecasting and visualising human mental statuses. The quantum mechanical probabilistic apparatus encodes observables into quantum information and decodes quantum information into observables on conventional computer hardware and quantum computer hardware. The quantum mechanical probabilistic apparatus detects measuring apparatus biasing interferences with the observed and avoids contamination with the measured environment. The quantum mechanical probabilistic apparatus learns emotional and mental states of humans and predicts the future path of emotional, mental states of once catalogued humans. The quantum mechanical probabilistic apparatus simulates emotional, mental states of humans and communicates with humans as autonomous identity. The quantum mechanical probabilistic apparatus utilises the apparatus measured, forecasted and algorithmic calculated emotional, mental states of observed humans as password and passcode to uniquely identify the humans under observation. Every new observation results in quantum mechanical probabilistic unique measure and forecast and new and unique passwords and/or passcodes.

### CROSS-REFERENCE TO RELATED APPLICATIONS

This application is a non-provisional application for patent entitled to a filing date and claiming the benefit of earlier-filed provisional patent application No. 62/570,372, filed on Oct. 10, 2017.

### FIELD OF THE INVENTION

The present invention relates to Artificial Intelligence Decision Support System apparatuses measuring, forecasting and visualising humanoid mental statuses. More particularly, the invention relates to a Quantum Mechanical Artificial Intelligence Decision Support System apparatus that is capable of predicting future state believes, desires, intentions, worldview and logical structures that an individual is likely to expose while moving forward in time.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Human unpredictability embeds in complex adaptive systematics. Violations of healthy speech pattern identify personal psychopathologies, psychotic organisational situations, and continuous suspension of intelligibility, truth, rightness, or sincerity. Pathological forms of communication leave identifiable traces in human communications. Pathological processes indicate power struggles between discourse protagonists. Believes, desires, intentions, worldview and logical structure are parameters observed in human communication.

Quantum combinatorial logic takes the place of statistics and single trajectory root-cause data analytics given that statistical correlations confine in static momentum. Multi-dimensional quantum space modelling offers several advantages to explain human beliefs, preferences, actions and irrational attitudes more complete.

However, transforming conventional, traditional store and retrieval procedures into reversible evolution, quantum-like store and retrieval procedures producing quantum mechanical probabilistic probability is unresolved and unaccomplished.

Available archive, store, search and retrieval mechanism for repeatable calculations of Hilbert complex vector space equations incorporating the notion of emotion and irrationality in human intentions to act as well as recognition, interpretation and processing of human non-linearity like mind, emotions and irrationality in context is incomplete and unfulfilled. Specific mathematical, theoretical verification of quantum-like algorithms along clinical, experimental domains draft on theoretical, abstract models of yet publicly unobtainable, inaccessible quantum computer hardware. Such quantum mechanical theoretical models commonly substitute failing Markov mathematics and explain experimental data more complete with quantum mathematical superior probability determination. However, such methodologies suffer many drawbacks that hinder practical, real-world application on conventional computer machines. Such methodologies are typically only able to execute on Quantum Computer once such Quantum Computing Hardware is available in order to apply the methodology correctly. Such deficiencies and limitations result in deferred, limited and very costly usage scenarios for only a small amount of people.

Another drawback is that direct influences from an observer on the observed or observer contamination of environmental factors in research setup result in biased measurements and renders the observed useless for purity determination. As quantum information theory predicts the collapse of the observed as an effect of the observer measuring the observed will not all non-linear, non-sequential hidden information be entirely accessible after the collapse, rendering the result useless. Precautionary apparatuses are mandatory ensuring scientific rigour verification procedures for claimed findings. Such apparatuses are unobtainable, inaccessible and unattainable for the realm of human communication in real-world business interaction scenarios.

Another further drawback is that such methodologies do not transform conventional computer store and retrieval procedures into reversible evolution, quantum-like store and retrieval procedures, a requirement before inexpensive public cloud computing hosted memory banks qualify for quantum computing simulation of quantum computing models.

Therefore, a need exists in the field for new and different quantum cognition systematics for recognition, interpretation and processing of human non-linearity like mind, emotions and irrationality in a business context to port findings and quantum-like systematics into innovative, available, attainable, achievable and inexpensive Artificial Intelligence Decision Support Systems.

Finally, there is also a need for algorithm allowing an apparatus application on vast scale to meet polynomial scale P and NP complexity requirements relevant for extending the apparatus to function on a global scale covering the entire human population. This ability permits to port this invention apparatus method and procedures on data streams in the non-simulated quantum computer once such quantum computing hardware is available.

### BRIEF SUMMARY OF THE INVENTION

The present invention comprises a novel methodology and apparatus converting human communicative action via applied quantum gate algorithms into reversible data for further superposition and entanglement operation. Quantum mathematically expressible mind state change mappings and the applied quantum prediction result in analytics of human uncertain, complex, and emotional events. Detecting and forecasting human irrationally, bias and other shortcomings in human decision making augment humans limited information-processing capabilities by visualising such in real-time.

In preferred embodiments, this invention computer operational procedures address on a global and real-time scale, for project teams, organizational 24/7 enterprise systems in global scenarios and eventually for the entire human population to augment or substitute failing humans as manager, given this invention decision problems are kept in upper bound polynomial complexity meeting class P and NP prerequisites. This invention computer operationalised apparatus result in Quantum Artificial Intelligence superior capabilities to keep up with details in real-time joined by quantum combinatorial logic and Quantum Artificial Intelligence superior future prediction abilities. This decision support apparatus augments or substitutes failing managerial processes let by humans. The attitudes, desires, and needs measuring apparatus machine learn the emotional and mental state of humans, predict the future path of emotional, mental states of once cataloged humans and eventually simulate emotional, mental states of humans. The invention introduces the quantum machine learned simulated mental states in real time as virtual identities into real-world via false memory implants so that physical persons participating in email communications and online discussion boards can entertain such as an identity. Such appear in language exchanges in virtualised context and are not distinguishable from virtual identities that represent real-world project participants or organisational members.

### BRIEF DESCRIPTION OF THE SEVERAL VIEWS OF THE DRAWING

Some embodiments of the present invention illustrate an example and not limit the invention by the figures of the accompanying drawings in which like references may indicate similar elements and in which:

FIG. 1 depicts how the apparatus measures, notates, encodes and decodes human communicative competence according to various embodiments of the present invention. The invented apparatus FIG. 1 depiction illustrates how the invention avoids measuring apparatus contamination with the measured environment. Transformation of standard, traditional, classic data processing into quantum conform data storage and retrieval mechanism illustrating how to avoid apparatus and observer to avoid contamination with the observed human and observe human's environment.

A copy process, before apparatus and/or observer influence is active on the targeted identity, duplicates the state of the targeted identity and therefore preserve the state of the targeted identity. This copy process, before apparatus and observer influence is active on the targeted identity establishes the ability to apply different factors of influence from VI (Virtual Identities) on TI (Targeted Identities) during the apparatus analysis phase. Long chains of influences are reversible to the original one-to-one state that consisted of TI collected observables like language, utterances or actions of observed TI. This reversibility to an original TI state builds the starting point to apply this invention algorithms producing new, modified VI (Virtual Identities) and AI (Artificial Identities) identities as result of this invention apparatus superposition and/or entanglement operations. As this reversibility is mathematically reproducible is scientific rigour verification of claimed findings possible at any time leading to acceptance in business usage scenarios.

FIG. 2 illustrates a perspective view of one example of a usage scenario utilising the invented notated quantum gate algorithms for encoding and decoding of observables. Encoding of data is subject of machine operational procedures aimed to produce visual representations of notated spaces and notated vectors and transition the same into human understandable visual representation for practitioners. Practitioner visualisation is histogram or bar chart visualisation for superposition calculations of hidden mental states. The underlying observable mental operations and the resulting consciousness is visualised as simultaneous states in Hilbert space as a multidimensional consciousness that is quantum mathematically formalised and visualised as a vector in Hilbert space.

FIG. 3 depicts an example notation applied as a suitable representation of mental states. Quantum Artificial Intelligence Non-Linear Orthography Logograms (QAINOL) is a reality created by social encoding. This standardised notation scientifically rigour denotes 4-dimensional quantum modelling for humanoid communication management.

FIG. 4 depicts an example notation for operations on components, e.g. time invertible quantum algorithm to encode influences of VI on TI. The depiction illustrates how the apparatus denotes reversibility for humanoid language elements, humanoid utterances, humanoid actions or non-humanoid environmental factors that went through the interference-encoding schema as well.

FIG. 5 depicts an example notation for algebraic nullification—common sense macro world perspective resulting in chaotic understanding given the missed information in the cancelled-out events (VIₓ).

FIG. 6 depicts an example notation for this invention apparatus Quantum Computing Algorithm representing the preservation of environmental nullification, cancelled-out events, as well as establishes reversible AND, addressing deficiencies in conventional scientific rigour (see utilisation in Quantum Artificial Intelligence Non-Linear Orthography Logograms (QAINOL) logogram: biStable (FIG. 24))

FIG. 7 depicts an example notation for this invention apparatus ability to transform any human communication situation in quantum computing reversible data repository in the conventional computer. This invention apparatus algorithm transforms classical data sources into quantum information.

FIG. 8 depicts an example notation for Algorithm ‘QRA3’. This invention apparatus algorithm transforms communicative situations into Quantum Artificial Intelligence Non-Linear Orthography Logograms (QAINOL) data repositories.

FIG. 9 depicts an example notation for VI influence causing adn_{TI} to go into superposition as a linear combination of TIₛₜ and TIᵥ (TI states & TI vectors) resulting in mental state positioning. Linear combination of TIₛₜ and TIᵥ is a mathematical expression for the unpredictability of human behaviour, the conventional, common sense understanding of the unpredictability of human decision-making.

FIG. 10 depicts an example notation for TI_{ST}, the measuring unit to calculate and forecast the invention apparatus algorithmic growth factor if this invention apparatus is kept in a non-measuring state of observation.

FIG. 11 depicts an example notation for this invention apparatus Quantum Artificial Intelligence Non-Linear Orthography Logograms (QAINOL) notation for traditional, current, and general common sense understanding of human unpredictability. This apparatus calculates common sense, conventional understanding as classic coin flipping intuition with 50/50 uncertainty, result of superposition calculation without interference.

FIG. 12 depicts an example notation for this invention apparatus algorithm preservation of the adn_{TI} initial state, resulting in new mental state vector if left in unmeasured dynamics and subject to another, additional influential interference, e.g. by a second VI.

FIG. 13 depicts an example notation for the state of adn_{TI} after second VI influence.

FIG. 14 depicts an example notation for reliable predictions of apparatus forecasted measurements.

FIG. 15 depicts an example notation for Quantum Artificial Intelligence Non-Linear Orthography Logograms (QAINOL) this invention apparatus uses for Mental State Equation (Logogram mentalStateEquation).

FIG. 16 depicts an example notation for multi-dimensional Qubit visualisation of multi-dimensional values in quantum combinatory logic.

FIG. 17 depicts an example notation for human understandable chart bar, causing and resulting in wave collapse of virtual identity depicted. This visualisation simplifies for humans decision-making on countermeasures or counter-action for real-world action planning.

FIG. 18 depicts an example of this invention apparatus implementation steps permitting one having ordinary skills in the field of the invention to make and use this invention. It illustrates a flow diagram according to an embodiment of the invention. The implementation steps begin at step 1 by setting up an observable humanoid communication utilising computerised operations. Next, in step 2, encoding occurs according to this invention Quantum Artificial Intelligence Non-Linear Orthography Logograms (QAINOL). In step 3 and step 4 is per observed human two cloud computing subscriptions to be set up which contain apparatus observed, and apparatus calculated information in cloud computing hosted memory banks. The step 5a apparatus calculation of hidden attitudes, desires, needs in conjunction with apparatus observed construct separable Hilbert spaces simulating a Qubit in step 5b by calculating one separable Hilbert space, labelled ‘Bra’ and add this to the separable Hilbert space of calculated observables, labelled ‘Ket”. In step 6, the apparatus predict this observed human's future communicative action resulting in visualisation in scientific rigour QAINOL notation and in easy to comprehend 2-D representation.

FIG. 19 depicts an example notation for Quantum Artificial Intelligence Non-Linear Orthography Logograms (QAINOL) artificial intelligence learning (Logogram: learningAI). The notation exemplifies this apparatus implementation on the real-world anonymized virtual workspace.

FIG. 20a/20b/20c depict an example notation for this invention apparatus determination and forecasting of human mental states, and their belief system (logogram mentalstatebelieves). Artificial Intelligence build up as cloning process of ever-increasing precision of this invention apparatus determination and forecasting of human mental states and their belief system. FIG. 20b and FIG. 20c are magnifying sections of FIG. 20a.

FIG. 21 depicts an example notation for determination and forecasting of human mental states and their mental state believes preferences (logogram mentalstatebelievespreferences).

FIG. 22 depicts an example notation for providing scientific rigour for disaster recovery scenarios given that reproducing a quantum qubit and all its rich information, e.g. TI_{2×0}, TI_{2×1}, TI_{2×2} execute on conventional inexpensive cloud computing hardware (logogram: biStable).

FIG. 23 depicts an example notation for generating bar chart representation by creating equivalent bit data structures out of qubit data structures (logogram wavecollapse).

FIG. 24 depicts an example notation for generating flat 2-dimensional bar chart reporting informing in real-time about current and forecasted dominant project group adnₙ determination and simultaneously utilise Qubit ‘believe’ and Qubit ‘preference’ to feed the AI mental state functions and the AI Qubits.

FIG. 25 depicts an example notation for measuring influences from an observer on the observed (logogram mentalSpaceEquation). This invention apparatus algorithm permits hosting multiplicity of human mentalStateEquation and qualifies for measuring the influence of supplementary environmental data, e.g. VI_{2×0}, Tᵢₓ and, T_{iy}. Any external system interferences or influences from an observer on the observed is detected, measured and stored by this algorithm into this invention separable Hilbert space data structure.

FIG. 26 depicts an example for utilising this invention apparatus measured and forecasted mental statuses of the observed human consisting of different, unique apparatus calculated parallel trajectories across time of an observed target of interest as identity and password and passcode.

FIG. 28 illustrates a flow chart of the identity and/or password/passcode routine, executed after step 8 of FIG. 18. In step 9a one partial Hilbert space, as depicted in step 5b/FIG. 18, is algorithmic separated and labelled ‘Ket’. The result is numerical, represents ‘Ket’ vector constellation, and further introduces as ‘Key’ in current, common, conventional industry standard user/password and/or application/passcode identity and access scenario. The vector constellation transmits to an exemplified computerised request for identity, password and passcode in step 9b. Step 10 receives an identity and access request from an exemplified computerized entity in step 9b and recalculates the missing Hilbert space in cloud computing memory bank in step 13 and step 14 by substituting step 15 with the key received in step 10. Step 12 represents recalculation of apparatus prediction. The first identity check is comparing the step 19 preserved separable Hilbert spaces, the ‘BraKet’ freeze, stored at the time of step 9a key issuing, with step 14 calculation. If step 18 results in identity for step 11 and 12, access granted forwards to identity and access requester. In case step 12 results in a wave-collapse determination by step 17, third-party manipulation evidences. If either step 11 or step 12 result in mismatch calculation with Hilbert space freezes of step 15 or step 19 step 21 executes communicating access denial to identity and access check requester.

### DETAILED DESCRIPTION OF THE INVENTION

In the following detailed description, reference is made to the accompanying drawings, which form a part hereof. In the drawings, similar symbols typically identify similar components, unless context dictates otherwise. The illustrative embodiments defined in the detailed description, drawings, and claims are not meant to be limiting. Other embodiments may emerge; other changes may evolve, without departing from the spirit or scope of the subject matter presented here. The components of the present disclosure, as generally described herein, and illustrated in the FIG.s, may be arranged, substituted, combined, and designed in a wide variety of different configurations, all of which are explicitly contemplated and made part of this disclosure.

The terminology used herein is to describe particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context undoubtedly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealised or overly formal sense unless expressly so defined herein. In describing the invention, it is understood that a number of techniques and steps disclose. Each of these has the individual benefit, and each utilises in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

This invention provides a methodology and apparatus for an understanding of the human mind and probability modelling of human behaviour. The apparatus provides procedures for handling or prediction of human behaviour by incorporating the notion of emotion and irrationality in human intentions to act. The invention compromises double stochastic models of data accumulation and visualisation of decision making by machine reasoning. Logic formulas and propositions are 4-dimensional quantum models for decision making converted into Logograms, representing computer operationalised formalised mental processes in organisational context. The invention models virtualised workspaces and produces visualised depictions, both grounded on the law of double stochasticity. A change model and operational-technical design for an inexpensive cloud computing praxis consistent implementation are outlined. Actionable Quantum Cognition systematics for recognition, interpretation and processing of human non-linearity like mind, emotions and irrationality in an organisational context are computer operationalised. This Synopsis of change model and quantum-like systematics results in innovation of a Quantum Mechanic Artificial Intelligence Decision Support System operating non-linear probabilistic for decision making under uncertainty for organisations.

Apparatus Basic Algorithm 1 (QRA1);
Influence encoding—reversible and mathematically verifiable.
Algorithmic encoding of companion TI, or VI or TI_{X}/TI_{Y} influence on TI.

Language is subject of this invention apparatus analysis resulting in simple language encoding schemas, e.g. pure ‘good’ or ‘bad’; applicable to the computational base 0, 1. This influence, e.g. companion TI influence on observed TI or VI influence on observed TI or influence of multiple TIs (TI_{X}/TI_{Y}) on observed TI, represent a fundamental and basic process of the apparatus. In this fundamental and basic process of the apparatus are two variable values from the observed input, e.g. language, used and recorded to establish reversibility. This reversibility for a general irreversible logic is required before the apparatus freely reconnect data collected during the data analysis phase or builds of predictive analytics for possible and potential states. The input for this invention apparatus is language, utterances and actions previously encoded via this invention Quantum Artificial Intelligence Non-Linear Orthography Logograms (QAINOL) encoding scheme. The influential factors considered can represent different interference constellations, e.g. a) VI to TI interference or b) interference from any other human/humanoid communicative actor on the TI which is target of evaluation (TI-TI interference), or c) represent any other environmental factor of interference resulting as influential to/on this TI (Component to TI interference). Any of such interference factors, independent from nature of influence or source of influence, is Quantum Artificial Intelligence Non-Linear Orthography Logograms (QAINOL) denoted as TI_{2×0} and TI_{2×1} interference and the resulting interference effect encodes as TI_{2×2} input stream (FIG. 4). A logical AND operation for TI_{2×0} and TI_{2×1}, e.g. representing two language elements that either had been issued by the TI itself, or by another TI to this target of evaluation TI, or by a VI to this target of evaluation TI, or that had been recorded from this TI which is target of evaluation, or any other utterances or actions or environmental factors that went through the interference encoding schema as well, is Quantum Artificial Intelligence Non-Linear Orthography Logograms (QAINOL) denoted as TI_{2×0}∧TI_{2×1} (FIG. 4). Any TI_{2×0}∧TI_{2×1} applies as quantitative value to the TI_{2×2} input-stream. This invention apparatus specific methodology is required as the influence from any TI on target of evaluation TI or VI on target of evaluation TI or any other of the described correlations is a logical AND, therefore irreversible (FIG. 5). To make these encoded data collected applicable as input to a model of reversibility, data require transformation into quantum information. This invention apparatus achieves this transformation via metadata augmentation, at the time of data collection. These two procedures, TI_{2×0}∧TI_{2×1} and applying the same as quantitative value to the TI_{2×2} input-stream metadata augment at the time of data collection or to merge in near real-time after encoding of data. Both procedures constitute this invention apparatus necessary capability to import human communication into mathematical apparatuses based on quantum gate modelling and is required to capture underlying interferences. Such interferences would otherwise be unnoticed and lost as they cancel out where they began.

This invention apparatus is globally applicable on today available consumer computer hardware independent from the availability of quantum computing hardware or quantum computing engineering aspects. The massive amount of human communication transformed into quantum information require this invention apparatus installed on cloud computing hosted memory banks resulting in quantum computing simulation of quantum computing models, e.g. quantum qubits for archive, store, retrieval, categorisation, indexing and quantum algorithm operations. Such an archive, store, retrieval, and quantum algorithm operations, simulating quantum computing on conventional computer hardware, are applicable as data streams onto real Quantum Computer once such Quantum Computing Hardware is available. The invention apparatus applies to qubits in real quantum computing environments as well. Until Quantum Computing Hardware becomes generally available, will cloud-computing tables simulate qubits and represent Qubits, hosting the observed and conditioned input.

Apparatus Basic Algorithm
Encoding of data

Humanoid interaction is subject of this invention apparatus Quantum Artificial Intelligence Non-Linear Orthography Logograms (QAINOL) notated quantum gate algorithms for encoding and decoding of observables. Encoding of data is abstract representation-independent Quantum Artificial Intelligence Non-Linear Orthography Logograms (QAINOL) notated bra-ket notation (FIG. 3). Textual encoded data represented by Quantum Artificial Intelligence Non-Linear Orthography Logograms (QAINOL) graphical notation, transform vintage store and retrieval procedures into reversible evolution, quantum-like store and retrieval procedures producing a probability, a variable or an Eigenfunction (any non-zero) representation. The probability amplitude is subject of machine operational procedures aimed to produce two visual and distinct representations. An accurate, visual representations of this invention apparatus Quantum Artificial Intelligence Non-Linear Orthography Logograms (QAINOL) notated spaces and Quantum Artificial Intelligence Non-Linear Orthography Logograms (QAINOL) notated vectors (FIG. 16) and transition the same into a second easy understandable visual representation (FIG. 17). Such easy understandable visual representation is histogram or bar chart visualisation (FIG. 17) of this invention apparatus superposition calculations of hidden mental states, after the TI_{space} (FIG. 3) state had collapsed and required re-application of reversible computing along the chain.

Apparatus Basic Algorithm 2 (QRA2)
Additional Virtual Identity influence

The invention apparatus algorithm exemplifies freeze/defreeze procedures of data to preserve apparatus and observer opportunities to perform time reversibility on data collected. From a business value point of view does this allow, once computer operationalised, to perform an anytime ad hoc previous target of evaluation TI state calculations from a current VI identity this TI inhabits. This VI identity can be a state prediction analytic delivered to the observer or apparatus user as a forecast of a to-be-expected behaviour of a TI under evaluation or is a ‘real’ VI identity representing an anonymised TI.

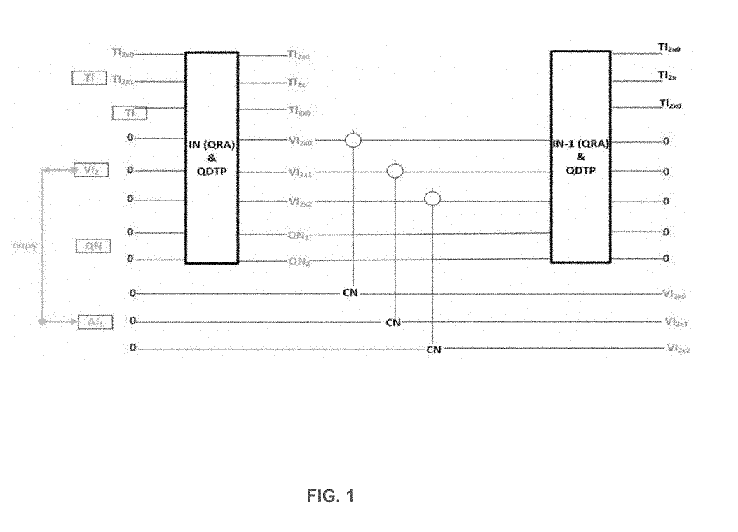

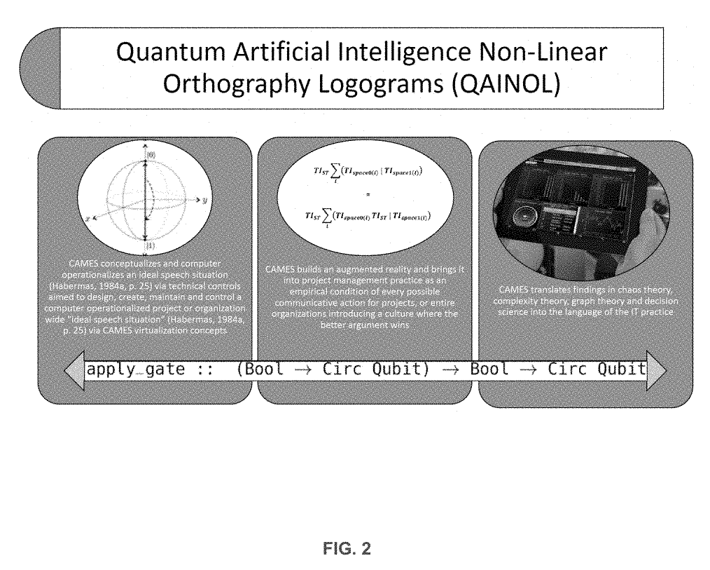

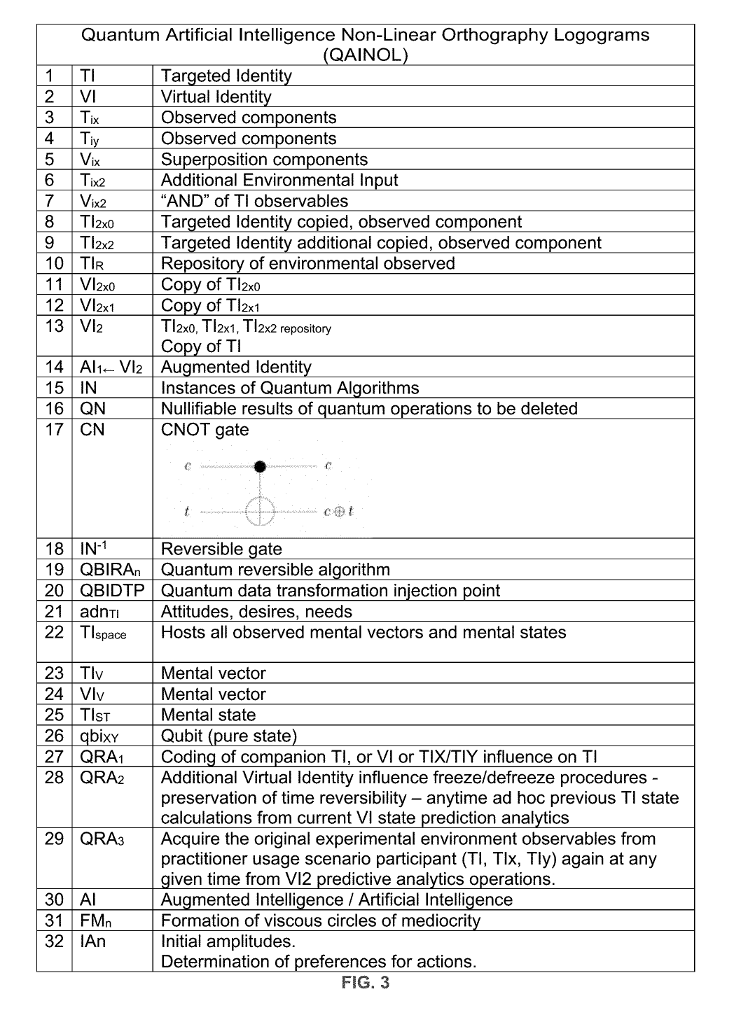

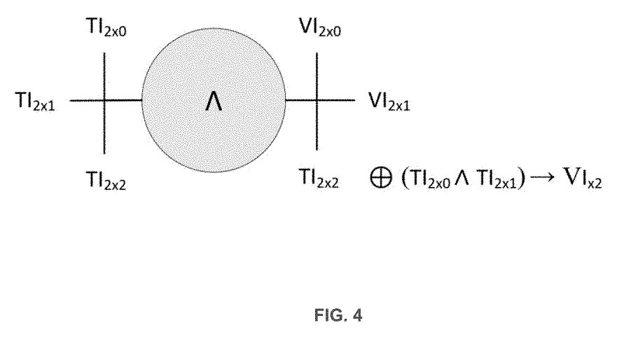

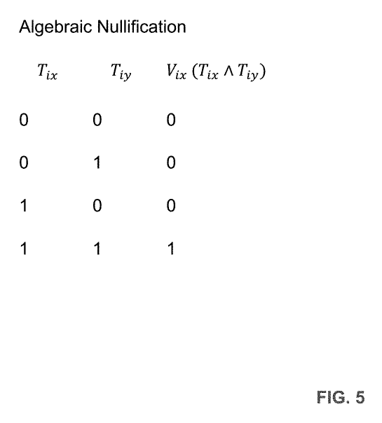

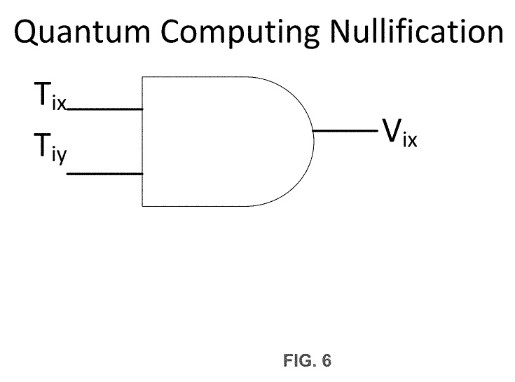

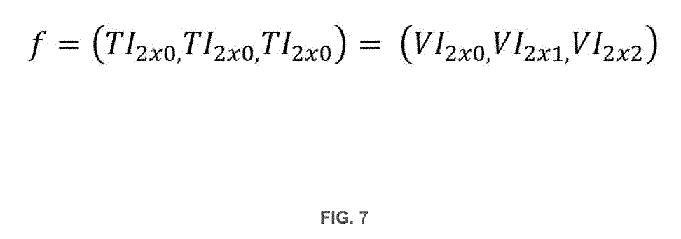

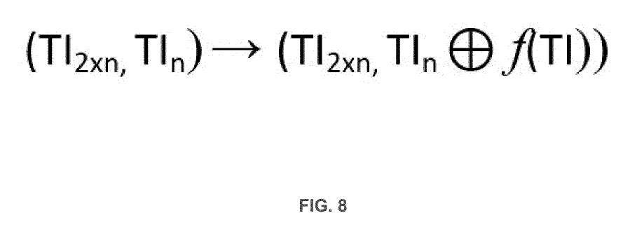

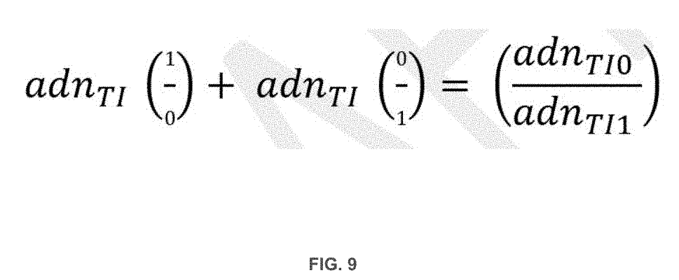

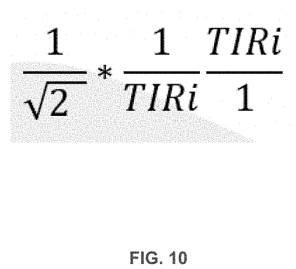

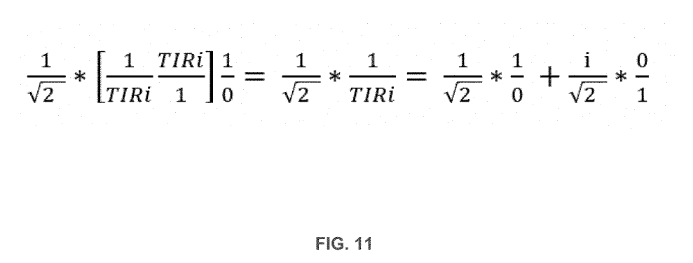

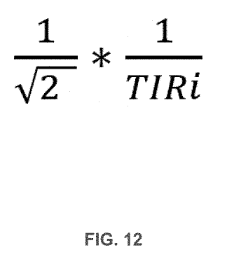

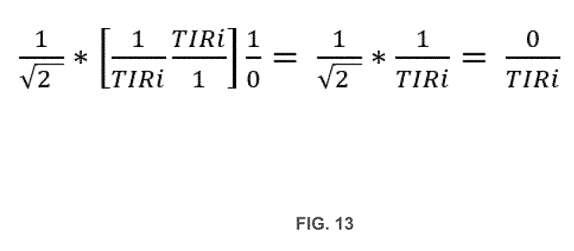

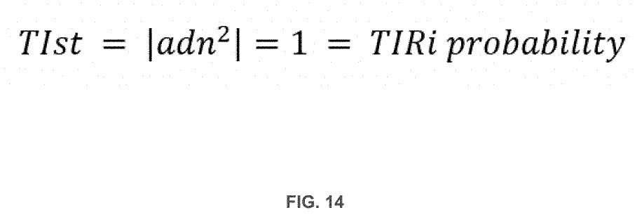

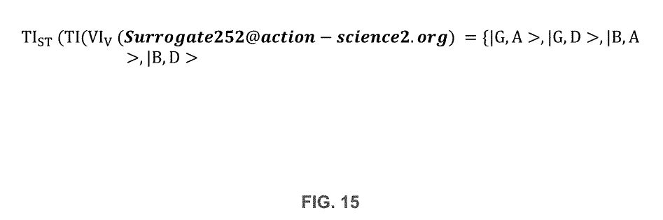

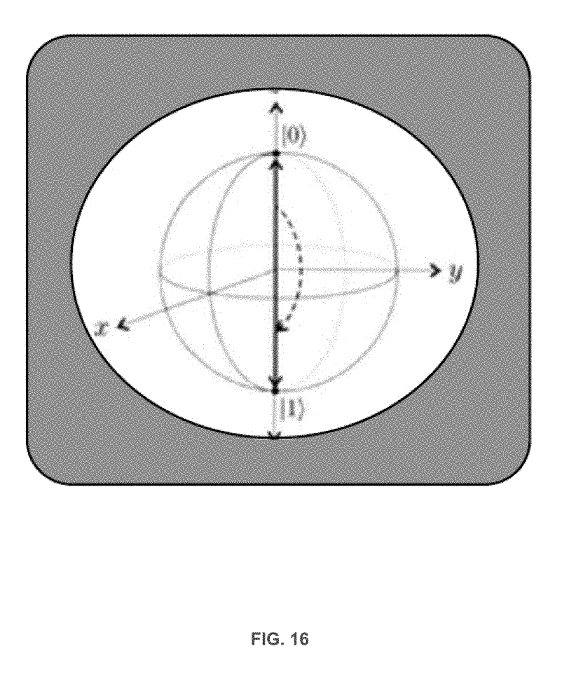

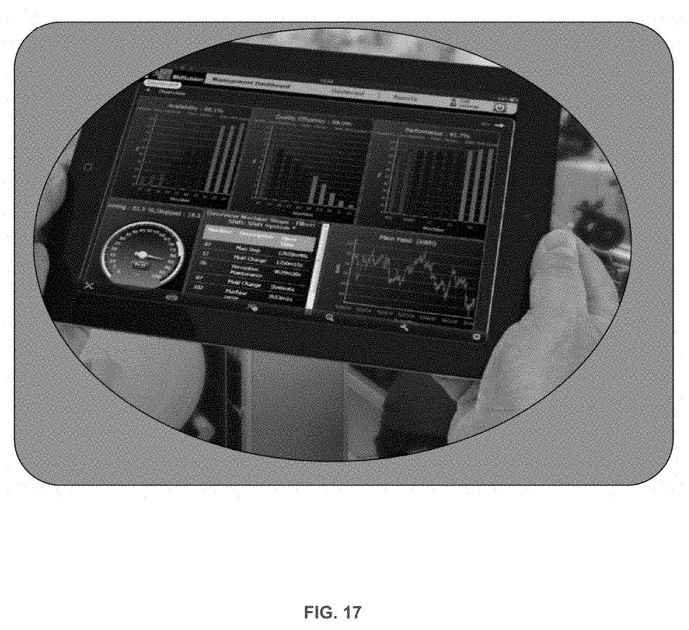

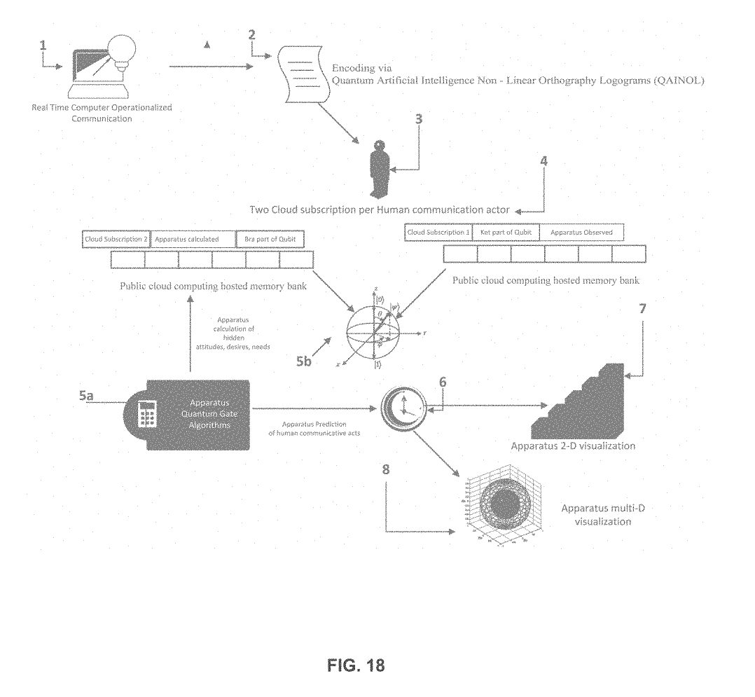

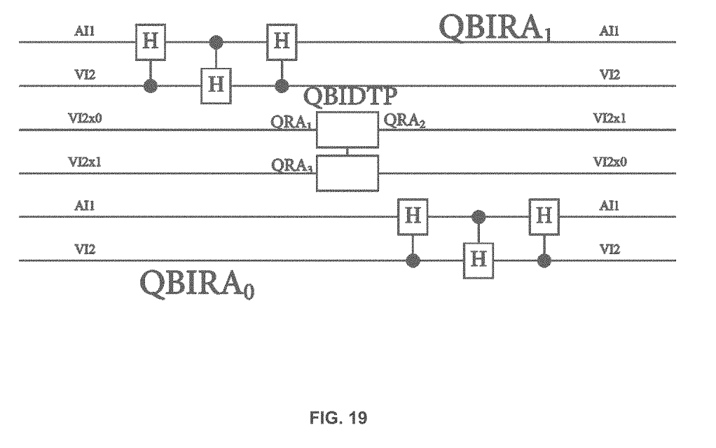

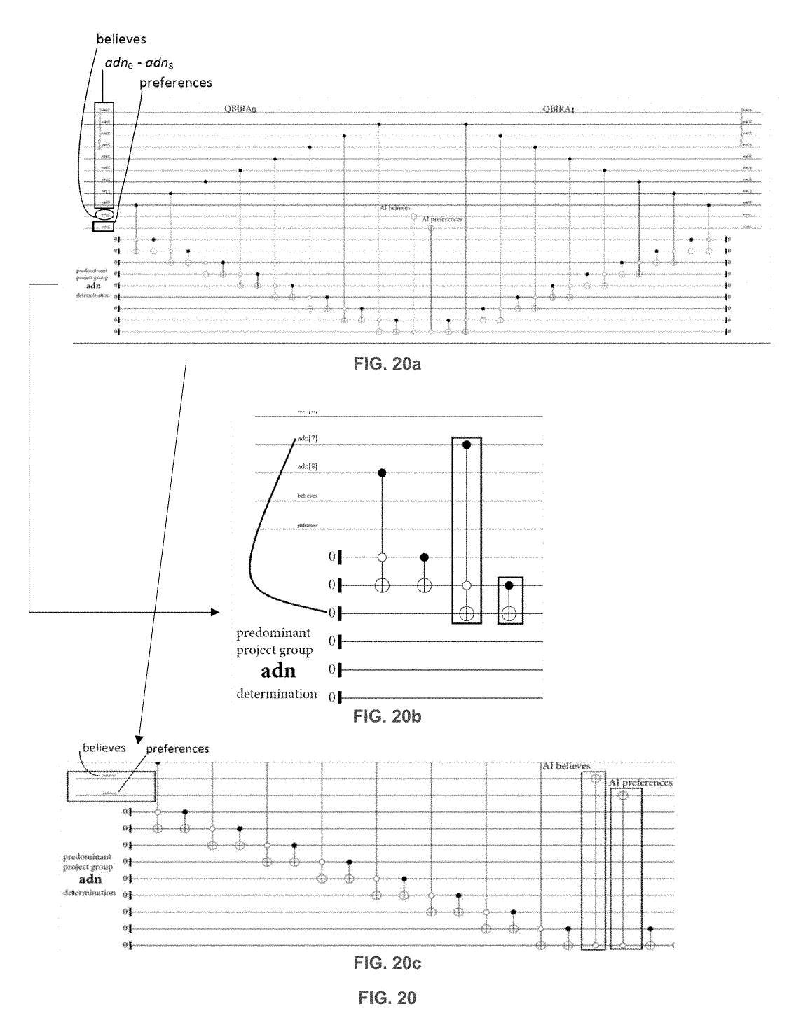

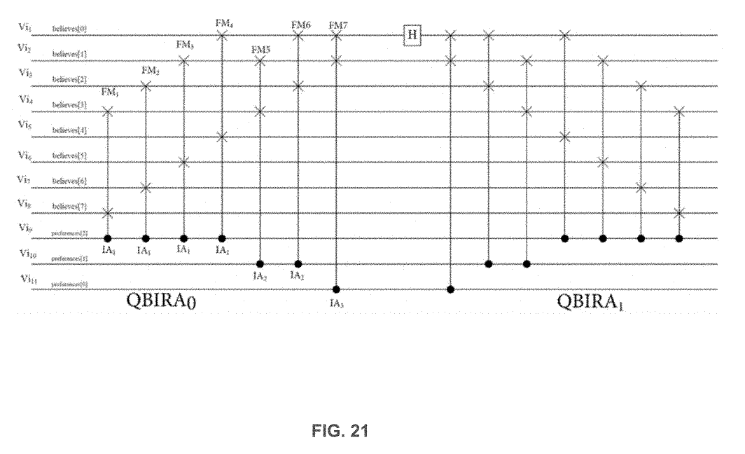

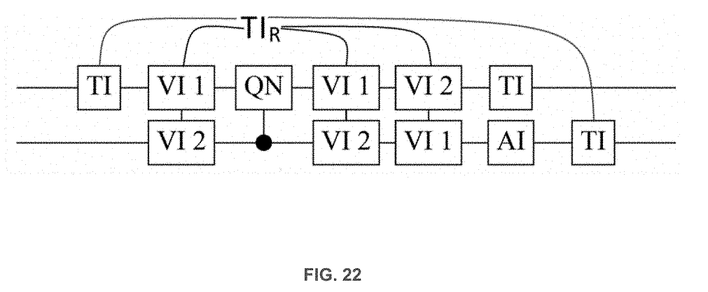

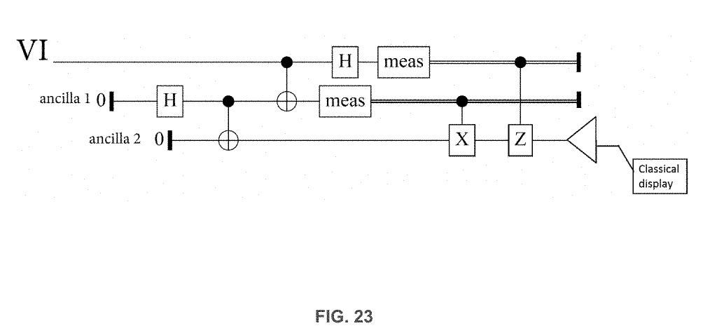

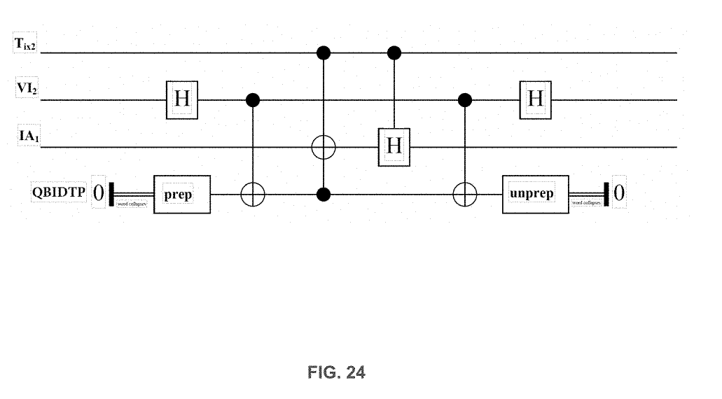

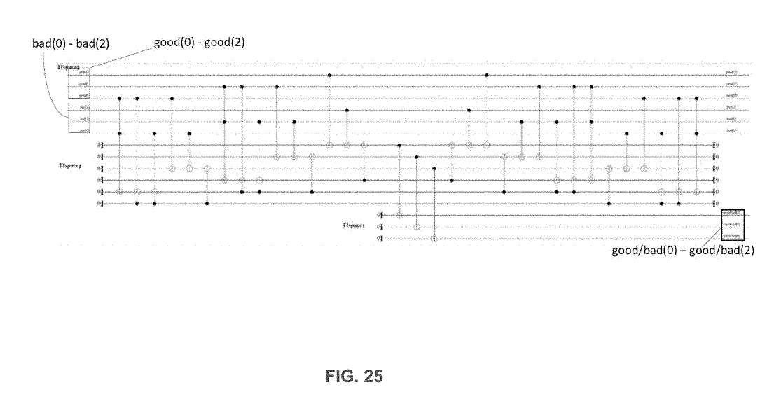

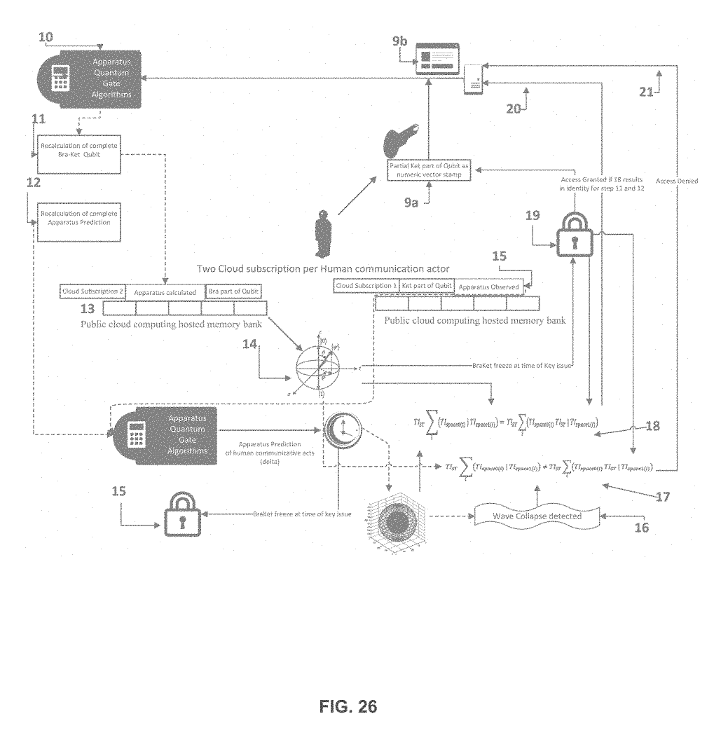

A freeze or snapshot of TI states (observed components) is performed. Any TI to VI state transition will not influence or change the TI state that had been preserved at the time of encoding. This preservation consists of a variable value, made up of language, utterances or actions from the target of evaluation TI at the time of data collection. This separation of further manipulation and modification activities by an observer from original data collection will keep therefore a one-to-one/state-to-state mapping relationship between TI recordings, and this TI obtained VI and the successor states of such VI. At any given time, can state-to-state validation procedures be performed, evidencing, verifying and preserving the presence of the principles of reversible evolution simulation for all these invention apparatus gathered data from human/humanoid communication where Quantum Artificial Intelligence Non-Linear Orthography Logograms (QAINOL) had been implemented. Any VI prediction analytics, e.g. prediction of foreseeable real-world observable TI communication, will be performed and executed on this TI copy, Quantum Artificial Intelligence Non-Linear Orthography Logograms (QAINOL) donated as VI₂ (FIG. 1), only. By modifying the additional input TI_{2×2} to 0 and discarding the copies VI₂×0 and VI₂×1 (FIG. 1), can a direct state-to-state relationship between TI and VI₂ be established to recalculate TI states from VI₂ states and vice versa. Again, will all further VI₂ operations be executed on this freeze or snapshot copy, Quantum Artificial Intelligence Non-Linear Orthography Logograms (QAINOL) denoted as VI₂. A defreeze can be performed as a reverse modification of VI₂ states by modifying/setting the additional input TI_{2×2} to 0 and by recovering the TI components TI_{2×0} and TI_{2×1} from VI_{2×0} and VI_{2×1} copies. This invention apparatus Quantum Artificial Intelligence Non-Linear Orthography Logograms (QAINOL) once apparatus computer operationalised (FIG. 18) leads to the implementation of reversible analytics for all data collected following this invention apparatus Quantum Artificial Intelligence Non-Linear Orthography Logograms (QAINOL) (FIG. 5) encoding schema.

This invention apparatus visualises geometrical thinking into real-time forecasts by using vector length and presents distance between vectors as angles. Real-time forecasts by using vectors transform unpredictability of the independent or uncorrelated, the chaos or the complexity, into TI_{space} of TIₙ dimensional relations. This n-dimensional relation is a one-to-one relationship between two TI_{V}. This relationship expresses in this invention apparatus as an additional structure. This structure is the result of calculations and attached as metadata to TI_{V}. The vector length is always 1 while the distance between vectors is the result of an inner product calculation. All subsequent calculations execute on metadata and not on the data itself. The TI_{V} occupy an area of dimensions 2n and some integer representing something. These 2-dimensions are, e.g. yes/no and/or good/bad and/or existing/non-existing and analogous expressions for positive integers representing real-world observables according to schemas developed.

Further and more complex calculations construct at a later point in time and execute on the larger unit made up from such small units, e.g. as a concatenation of two small units. This invention apparatus only executes elementary calculation like *, +, −, and √. These 2-dimensions are made of complex numbers, defined as a mix of non-observed imaginary numbers augmenting real observed values, again analogous to custom schemas. The resulting geometrical representation is based on the production of negative real numbers that extends the prior |adn|2=1 probability with |adn|2=−1. This simple approach applies via apparatus maintained large tables using the same, identical time slot for execution of such a machine operation and does, therefore, qualify to address decision problems of complexity class P and NP as the algorithm upper bound is in the size of the input. The resulting two states are hosted by this invention apparatus (FIG. 18) as Qubit providing access to both anytime, the superpositioned TI observed states and the artificial identity states, calculated as the VI state of TI or as AI states for the artificial identity (FIG. 2).

Apparatus Basic Algorithm 3 (QRA3)
Un-contaminating interference experiments

This invention apparatus algorithm reversibly acquires original observation environment observables from humanoids, e.g. TI, TIₓ, TI_{y} (FIG. 1, FIG. 3). This logic applies at any given time from VI₂ predictive analytics operations. This invention apparatus algorithm allows large application on colossal scale to meet polynomial scale P and NP complexity requirements. Multiple humanoid communicative actors (TI, TIₓ, TI_{y}) that went through their corresponding TI->VI₂ (AI₁) (FIG. 1) transformation can be subject of retransformation without affecting the overall analytic calculation time. As long as algorithm start and algorithm finish time of the transformation TI->VI₂ (AI₁) (FIG. 1) is for all observed humans/humanoids (denoted as TIₙ) occurring at the same moment in time the resulting polynomial. Only one-time slot is required (IN=1) to apply QRA₁ or QRA₂ across all observed humanoids resulting in one instance, denoted IN (FIG. 3), and meets polynomial performance constraints regardless of the size of the data or the number of humanoids under observation. This invention apparatus algorithm, therefore, qualifies to address decision problems of complexity class P and NP as the upper bound is the amount of TI and VI₂ (AI₁) and therefore polynomial and in the size of the input for the algorithm resulting in O(TI+TI IN). Only VI₂ and AI₁ states are from now on and for subsequent operations subject of simple and pure reversible operations (FIG. 1) that will make up this invention apparatus Quantum Artificial Intelligence Non-Linear Orthography Logograms (QAINOL) notated (FIG. 3), quantum gate framework based predictive analytics operations. Again, all applied only after the initial transition from TI to VI₂ (AI₁) (FIG. 1) had been processed resulting in the establishment of observer un-contaminated simulation environment. As the principle of reversibility is kept for ongoing processes and prevents the overwrite of values in VI₂ registers will VI₂ be copied into AI₁ (FIG. 1). These pure and straightforward reversible operations, applied to the transition of VI₂ to AI₁ itself are again invention apparatus quantum algorithmic. Invented apparatus algorithms are sequences of quantum gate operations and apply during data analysis phase. There is a variety of quantum gates, but this invention apparatus Algorithm 3 (QRA₃) only applies simple CNOT gates. Such CNOT gates are simple operations resulting in XOR of VI₂ (TI_{2×0} and TI_{2×1} and TI_{2×2}) data. The resulting XOR values are copied with the value initially in the VI₂ copy of TI, denoted A1 (FIG. 1) by setting the components in the VI₂ and A1 copy to 0 (FIG. 1).

This invention apparatus algorithm transforms standard data processing towards reversible evolution like storage and retrieval mechanisms and performs for a multiplicity of TI while still meeting the P and NP complexity standards. The IN⁻¹ instance as well performs for an unlimited number of observed humans/humanoids (TI) inside of polynomial constraints, resulting in obtaining the initial and/or starting state of the target of evaluation TI.

This apparatus combines the application of algorithm QRA1, QRA2 and QRA3.

All three algorithms constitute one pattern: A reversible implementation (FIG. 8). This invention apparatus algorithms QRA1 (QRA₁), QRA2 (QRA₂) and QRA3 (QRA₃), provide the logic of reversible evolution as repeatable procedures allowing make and use of this invention apparatus by one having ordinary skills in the field of the invention. This invented apparatus transforms non-reversible data and/or non-reversible data handling procedure into reversible data and reversible data handling procedure. Any humanoid communicative action transforms from TI and real identities into VI (virtual identities) (FIG. 7). Any such transformed is subject of subsequent mathematical apparatuses applying superposition and entanglement operation where reversible evolution is the pre-condition for utilisation of Quantum Artificial Intelligence Non-Linear Orthography Logograms (QAINOL) (FIG. 3) quantum gate algorithms QRA₁, QRA₂ and QRA₃.

This invention apparatus transforms any language conversation into quantum prediction analytics and ergo any speech situation into this invention apparatus Quantum Artificial Intelligence Non-Linear Orthography Logograms (QAINOL) (FIG. 3) quantum decision support systematics. This invention apparatus analyses and optimises humanoid communication processes via detection of first crisis indicators in distorted communication and communicating such via natural and easy understandable representation (FIG. 17).

This invention apparatus measures humanoid attitudes, desires, and needs.

This invention apparatus usage scenario requires implementation procedures (FIG. 18) and can be made and use by anyone having ordinary skill in the field of my invention. This invention apparatus setup requires interfacing with commonly available communication tools like Microsoft Office 365 or any other chat environment available in public internet where humanoids express their attitudes, desires, and needs denoted adn (attitudes, desires, and needs (FIG. 3)). This invention apparatus targets humanoid expressed individual self-interests and investigate via this invention apparatus measuring apparatus 2-state system where the expressed attitudes, desires, and needs present a ‘0’ and the hidden attitudes, desires, and needs represent a ‘1’. The probability that the hidden attitudes, desires, and needs are what can be observed in a predicted humanoid communication is defined with probability |adn|²=1. Prediction calculation measurement is delayed until a second VI influence hits the humanoid target of evaluation (TI) so that the hidden adn will turn out in the ‘1’ path with probability |adn|²=1. The first VI influence causes superposition and results in two paths. The second VI influence will cause the two paths to interfere and consequently to cancel out the ‘0’ path. This apparatus prediction calculation measurement is a pattern of observable interference applied throughout this invention apparatus measurement of observable human conversations. Short term observed communication, therefore, remain on the assumption that human/humanoids continue in strategic communication patterns, and their language, utterances and actions exploit their self-interested hidden decisions. This invention apparatus injects assertion into the communicative discourse stimulating humans/humanoids expressing their attitudes, desires, and needs by appearing as VI.

Humanoids start based on pre-experimental discourse patterns represented by the ‘0’ path and randomly select whether to continue along the ‘0’ path or to reflect into the ‘1’ path. According to this invention mathematical apparatus cause VI influence the human/humanoid participant (TI) to go into a superposition of both, e.g. the strategic ‘0’ and the consensus-driven experimental ‘1’ paths or vice versa. Visual representation of state vectors represents superposition as a combination of vector paths in linear form. This linear combination between ‘0’ and ‘1’ state vector paths define general path state. By applying a non-intuitive understanding to the behavioural results, this invention apparatus Quantum Artificial Intelligence Non-Linear Orthography Logograms (QAINOL) (FIG. 3) utilise superposition and interference to explain the human unpredictability as the effect of interferences. Since humans can expose only one behaviour at the same point in time is mathematically probability calculation of measurements required, after superposition is observed or calculated by the apparatus. Such calculation results in pinpointing the mental state of the humanoid, e.g. somewhere between adn_{TI0} and adn_{TI1}, representing either strategic or consensus-driven (FIGS. 2/10/16) orientation. Such measurement therefore not solves the problem at hand and this invention algorithms apply a second VI influence in order to leave enough opportunity that after the superpositioning the interference can effect. Only after such delay in measurement, defined as applying the measurement apparatus only after the second VI influence had occurred, state path calculation occurs in this invention apparatus. At both times, defined as first time VI influence and as second time VI influence, are mental state vector multiplied by a matrix. This operational multiplication procedure is a mathematical apparatus algorithm calculating and representing the probability of the adn_{TI} presence in a given 2-state apparatus system. The vector 1/0 represents the mental state for adn_{TI} in path ‘0’. Vector 0/1 represents the mental state for adn_{TI} in path ‘1’. The first VI influence causes the participant to transform its current state towards a move into both states and follow both predefined paths for the states, constituting the superposition. Such path calculation and the humanoid communication scenario applied by this invention apparatus is to occur in computerised human/humanoid communication in order to be represented by this invention apparatus as a 2-state system of a yes/no, and/or good-bad and/or found/not-found and/or strategic and/or consensus-driven communication. This invention apparatus operation learns the apparatus a 2-state system where the result of a calculation provides the basis for the machine to decide for a mental state via probability calculation of two paths and enables this invention apparatus to act as a behavioural, emotional and intentional artificial intelligence decision-making system. This invention apparatus algorithm learns the apparatus emotional and mental state of humans, predict the future path of emotional, mental states of observed humans and eventually simulate emotional, mental states of humans as an Augmented Identity (AI) and, once acting full automated and autonomous, like Artificial Intelligence.

By calculating and assigning a probability, at any given transition from state to state, this invention apparatus machine-learning algorithm collect measurements and attaches such to the adn_{TI}. By executing this apparatus, the apparatus user meets and completes this invention model for human/humanoid mental states (FIG. 11). Consequently, is human uncertainty then subject of this invention apparatus calculated state probability weighting the probable ‘0’ or ‘1’ at the second argument leaving first state measurements of language exposing mental states as the average uncertainty, weighted by the probability of being in the associated states.

This invention apparatus scientific rigour transforms into repeatable procedures to make and use it by anyone having ordinary skill in the field of this invention. Whenever observed human influenced by a VI, the observed human mental state vector multiplies by a simple matrix. Therefore, is the postulate not to measure after the first VI influence, as quantum interference has not occurred, yet. Given the applied calculation starting in path ‘0’, after passing through the first VI influence, the result comes out in a state of unpredictability (FIG. 9). Any intervention apparatus implementation will not measure and_{TI} after first VI influence resulting in the preservation of the initial state of mind (FIG. 13) observed humanoid started. Preserving the adn_{TI} initial state (FIG. 13) and influence a second time via VI without stimulus by measuring apparatus on results in this new state vector (FIG. 14). Details about the reasoning process of observed humans are unmeasured at that time. The second VI influence on TI, as the formula depicts (FIG. 2), cancels out the ‘0’ path as a result of superposition interference. The 50/50 flip-coin uncertainty of human behaviour forecast (FIG. 12) after the first VI influence is reduced to a calculated probability calculation: |adn|²=1 (FIGS. 2/10/16).

This invention apparatus Quantum Artificial Intelligence Non-Linear Orthography Logograms (QAINOL) (FIG. 3) pattern influence and measurement procedures, demanding two VI influences on TI mental states and result in reliable predictions for this invention apparatus measurement (FIG. 12).

Storing, archiving and retrieval of observed data in TI_{space}. This invention apparatus mimics, and any this invention apparatus Quantum Artificial Intelligence Non-Linear Orthography Logograms (QAINOL) observation of human communicative acts detect systems composed of attitudes, desires and needs with specific properties like intentions, dispositions, feelings interacting according to the specific schema of human communicative interaction. These specific schemas of human communicative interactions are apparatus power laws, e.g. power-law of formation of vicious circles of mediocrity. There will be various possible observations of consistency with the law of formation of vicious circles of mediocrity. Every observation of motion towards the law of formation, e.g. of vicious circles of mediocrity declares a mental state in this apparatus (FIGS. 1, 10, 12). Any such state exposes as a superposition of other states. This single superposition mirror one, or two or even more other states. This invention apparatus establishes quantities of quantum mathematical nature so that simple arithmetic procedures (+−*√) can be applied to eliminate any exponential or superpolynomial operations, qualifying this intervention apparatus for human/humanoid observations of complexity class P and complexity class NP. These invention apparatus calculated quantum mathematical quantities produce other invention apparatus calculated quantum mathematical quantities but given the same simple arithmetic procedures (+−*√) are applied again are they of the same kind, polynomial. One of these invention apparatus calculated quantities produced by applying intervention apparatus metadata and invented power law schemata to the raw data are vectors. This invention apparatus calculated states are considered particular mental states made up from intentions, dispositions, feelings, attitudes, desires and needs and accordingly labelled, e.g. TI_{ST1}, as a summary of intentions, dispositions, feelings, attitudes, desires and needs of one single targeted identities state of mind (FIG. 15). The same particular state is a source to apparatus creation of graphical, visual representation of such state utilising a specific, particular vector that entails its numerical to the label, e.g. TI_{V1}. Important is that this labelled vector, as well as all other vectors that received a label, exist in the same apparatus vector space. This apparatus vector space, therefore, hosts all remaining other possible states of an apparatus observed human communicative interaction so that this apparatus vector space hosts all elements of the system. The label of such detected system is the label for space, e.g. TI_{Space1} and/or TI_{Space2} (TI_{SpaceN}). This invention apparatus Quantum Artificial Intelligence Non-Linear Orthography Logograms (QAINOL) notation is adopted for encoding of observed human/humanoid communicative interaction as well as for the apparatus data analysis phase. The state vector TI_{V1}, therefore, is depicted in this invention apparatus Quantum Artificial Intelligence Non-Linear Orthography Logograms (QAINOL) notation as |TI_{V1}>. TI_{ST2} represents the superposition of two other states, TI_{ST3} and TI_{ST4}, the relationship is expressed as |TI_{ST2}>=TIᵥ₃>TIᵥ₄> as elements of TI_{Space1}. TIᵥ₃ represents a relationship to a state, here the state TI_{ST3}. This TI_{ST3} state denoted negative attitude progression and opposed behavioural in graphical representation Y-direction (FIG. 16). State TI_{ST4} might represent a parallel behaviour progressing in a positive graphical representation X-direction (FIG. 16) or vice versa. The sum of these two states represents a TI whose level of opposition makes a specific angle with both the negative attitude direction and the positive attitude direction in correlation to quantum-like analogies.

The new states, the subject of this invention apparatus build process, are results of calculations and no longer represent directly observed states, produced to visualise the contradictory as an angle of direction x, building a surface. This surface builds by apparatus metadata to the superposition of states TI_{ST3} and TI_{ST4}. This invention apparatus metadata applies a ranked metric. The invention apparatus measures the distance between spaces as the radius. Forming a new TI mental state by combining others is performed by calculating the distance between this TI and these other TI mental states as cos a| TIv3>+sin a| TIv4>. Building a new superpositioned mental state, just from the observed mental state, would be pure speculation and is logically wrong as cos a| TIv2>+sin a| TIv2> will result in the same identical state as there has no vector change occurred and the supposed state would be based on the same vectors that built from the observed vectors TI_{X1}|TIᵥ₂+TI_{Y2}|TIᵥ₂=(TI_{X1}+TI_{Y2}) TIᵥ₂ resulting in equality of vector |TIᵥ₂> and the new superpositioned vector −|TIᵥ₂>. This nullification does therefore not occur, as apparatus disabled. Nullification for the observed can occur but will then be based solely on the observed and not on state or vector arithmetic. If for example observed values result in a nullification, defined as no vector distance, e.g. TI_{X}+TI_{Y}=0 will a null vector be declared, denoted |TIᵥ₀>. This is required to be archived, results in a ‘no state’ and potential incorporation of this mental state null vector into this invention apparatus quantum calculations will not have any effect at all on this invention apparatus quantum mechanical probabilistic apparatus measure, forecast, visualize of humanoid mental statuses as |TIᵥ₂>+|TIᵥ₀>=|TIᵥ₂>.

All states of this intervention apparatus have bijective relations to each other state in the intervention apparatus calculated system. Every state constituent of one TI, e.g. TI₁, is unidirectionally connected with exactly one constituent of another TI, e.g. TI₂. This is calculated for any observed value influencing TI, e.g. T_{IX} or T_{IY}. In case of VI influence on TI, every element of this VI pairs with exactly one element of the influenced TI. This bijective relation is valid for all elements considered in this intervention apparatus. Any element missing bijective attributes excludes from this intervention apparatus systematics. This communication between elements is an apparatus function that unidirectional connects a component of the first state to a component of the second state resulting in a surjective relationship where f(TIₙT_{IX2})=TIₙ₊₁T_{IX2} if every element T_{IX2} in TIₙ₊₁ has a corresponding element T_{IX2} in TIₙ, e.g. f(TI₃T_{IX2})=TI₄T_{IX2}. Such mapping of TIₙT_{IX2->}TIₙ₊₁T_{IX2} can extend to TIₙT_{IX2}+TIₙT_{IY2>}TIₙ₊₁T_{IX2}.

Given the unidirectional orientation will every this intervention apparatus calculated mental state contribute to quantisation of the unpredictability of human behaviour. This quantification in this intervention apparatus space, e.g. TI_{space1}, calculates as apparatus quantum ket operation means apparatus only considers observables or calculation to/from observables measured as one state, never as a multiplicity of states nor a portion of a state. Parameters representing values between 0 and 1 are not denoted in any way, not as a magnitude, or length, or amplitude nor will these values be considered as fine-grained information and therefore are frequency or wave-length representations obsolete in this intervention apparatus TI_{space1}. This intervention apparatus are neglecting result in vectors with unit length only considering direction vs same direction and length as a parameter to distinct states. As a result are solely real numbers utilised as a weight to calculate opposing states. This intervention apparatus TI_{space1} visualisation of opposed states is circularly pictured as a superposition of two states of equal amplitude. The distance is shown as a flat area, the subject of further calculations to identify orthogonal directions that can be subject of input for schema-based coordinates to transform metadata of the observed into phase quadrature of this intervention apparatus _{space1}. This visual representation depicts superposition of a state as circularly opposing of states. This superposition mental state divides in two directions to comply with apparatus strict rules for meeting superposition requirements. First need a TIₛₜ to be located with x-direction, e.g. TIₛₜ₂ and second needs another TIₛₜ, e.g. TIₛₜ₃, the opposing state, to be located that is heading in the y-direction. Whatever the resulting angle will require a graphical representation as superposition specific modifications by the apparatus user. In order to produce an easily comprehensible graphical representation, need the second state, e.g. TIₛₜ₃, be 90° out of phase with the first and former state TIₛₜ₂. Only then, apparatus calculates the y-direction required creating a simplified histogram or bar chart representation showing the grade of mediocracy for the project, for the organisation or for the internet community that was subject of this invention apparatus observation. This intervention apparatus, therefore, provides a summary of three different representations of the apparatus space, a) the practitioner histogram b) the circular space or c) the Dirac notation (FIG. 3). As an alternative for graphical representation can Dirac notated complex number express superposition numerical linear. Only the last two are accurate representations allowing further procedures, e.g. weighting with relative phase to consider numerical circularly opposed state, e.g. |TIₛₜ₂+i|TIₛₜ₃> in apparatus space. The overall dominating relationship, expressed in this formula, keeps the common direction for all opposing TIₛₜ by incorporating complex numbers into the general path. This cannot be accomplished via histograms or bar charts for easy comprehension, and non-scientific representation require trigger and event handling to keep this invention apparatus algorithm in complexity class P and NP. This unifying unidirectional drift, expressed in Dirac notation as T_{IX2}|TIₛₜ₂+T_{IY2}|TIₛₜ₃>, turns the entire apparatus archive, store, search and retrieval mechanism into repeatable calculations of Hilbert complex vector space equations. For any apparatus observation scenario setup does that mean that all TIₛₜ represent the entire TIₙT_{IX2}+TIₙT_{IY2>}TIₙ₊₁T_{IX2} relations.

Dependency declarations in TI_{space} space between TI. As more than one observed human contributes to any human communicative act, exist more than one apparatus space. In case one apparatus space state, e.g. representing Targeted Identity 3 (TI₃) states, can be articulated by apparatus as combination of vectors in other apparatus spaces representing other TIs, e.g. |TI₄> and |TI5>, can linear dependency between apparatus spaces be formulated, e.g. as |TI_{3>}=TI_{X2}TI₄+T_{IY2}TI₅. A dependency between a dedicated TI, e.g. TI₃ and other TIs exists if for example |TI₃ is dependent on TI₄ and TI₅. This situation would declare that the state of space TI_{space1} for TI₃ is in a superposition of the states from TI₄ and TI₅. All vectors and therefore all states resulting from such a dependent vector are apparatus explained as a combination of other vectors, also qualify for the dependency statement and can occur between/across apparatus spaces and inside of apparatus spaces. Dependency detection between apparatus spaces constitutes already if only a single one out of a set of vectors/states meets the criteria. The criteria for independence between apparatus spaces is met if none, not even one vector or state can be defined as a linear combination of other vectors. The entire set is therefore either dependent or independent based on a single finding of linear combination to other vectors or states that defined according to language, utterances, actions found by other TIₛₜ. The number of independent vectors emerging in apparatus space defines the dimensionality of space. To recall, any state inside space that does qualify to visualise opposing states is moving into the z-direction of the unidirectional space. Therefore, has Ti_{space1} only two dimensions as the opposing ends of a flat area where one opposes in the x-direction, and the other opposes in the y-direction are always only two. Any Ti_{space} has a finite number of independent states denoted as N and all possible Ti_{space1} visually represent as an N-dimensional space.

In the end, will the practical value of this invention apparatus human communicative action observation be determined if and how this invention apparatus space calculates human communication as a minuscule system, to archive data, store data and retrieve data as a complex vector space of 2 dimensions.

What is claimed is:

1. A Quantum Mechanical probabilistic apparatus measuring, forecasting and visualising humanoid mental statuses comprising:
a. porting observer interferences onto ancilla vs on the researched and observed
b. encoding and decoding of observables into non-linear quantum information on conventional computer hardware;

2. A Quantum Mechanical probabilistic apparatus of claim 1 further comprising:
a. excluding measuring apparatus contamination with the measured environment;

3. A Quantum Mechanical probabilistic apparatus of claim 1 and claim 2 compromising machine learned emotional and mental state of humans, predicting the future path of emotional, mental states of once catalogued humans and eventually to simulate emotional, mental states of humans as an Augmented Identity (AI) and, once acting autonomous, like Artificial Intelligence;

4. A Quantum Mechanical probabilistic apparatus of claim 1 and claim 2 and claim 3 further comprising;
a. utilising the apparatus calculated coexisting, parallel trajectories across time for an observed target of interest as password/passcode
